(19) United States
(12) Patent Application Publication
(10) Pub. No.: US 2013/0097027 A1
(43) Pub. Date: Apr. 18, 2013

(54) Task-Based Advertisement Delivery

(71) Applicants: Taifeng Wang, Beijing (CN); Tie-Yan Liu, Beijing (CN); Bin Gao, Beijing (CN); Tao Qin, Beijing (CN)

(72) Inventors: Taifeng Wang, Beijing (CN); Tie-Yan Liu, Beijing (CN); Bin Gao, Beijing (CN); Tao Qin, Beijing (CN)

(73) Assignee: MICROSOFT CORPORATION, Redmond, WA (US)

(21) Appl. No.: 13/272,844

(22) Filed: Oct. 13, 2011

(51) Int. Cl. G06Q 30/02

(52) U.S. Cl. 705/14.71; 705/14.4; 705/14.73

(57) ABSTRACT

A task guidance tool that displays instructional steps and associated advertisements may facilitate the accomplishment of a task by users who are otherwise unfamiliar with the task. The task guidance tool may be developed from input data mined from various sources. The task guidance tool may display a series of step pages in which each step page include instructions for accomplishing a corresponding step of the task. Further, one or more step pages of the task guidance tool may be provided with selected advertisements that are displayed with the step instructions.

### BACKGROUND

Online advertising is an advertisement delivery technique that delivers advertising content via web pages. Online advertisements may include non-contextual advertisements that are not directly related to the content being viewed by a user, or contextual advertisements that are related to the content that the user is viewing on the Internet. However, most users who are browsing online are more interested in accomplishing specific tasks, such as viewing content related to a subject or topic, rather than viewing advertisements that in many cases are irrelevant to their interest. Further, when web pages regularly show online advertisements in certain web page sections, users may be conditioned over time to perceive such advertisements as part of the web page background and ignore the advertising content in such advertisements.

In other instance, relevant online advertisements may be delivered to a user while the user is engaging in specific activities, such as updating a social network web page or playing an online game. While such relevant online advertisements may be delivered to a user while the user is focused on a closely related task, such online advertisements may nevertheless fail to capture the attention of the user.

### SUMMARY

Described herein are techniques for providing task-based advertisements that offer goods or services that facilitate the accomplishment of a specific task by a user. The techniques may include the development of a task guidance tool that breaks down a complicated task into multiple steps. For each of the multiple steps, the task guidance tool may offer instructions for accomplishing the step. In addition to providing instructions for each step, the task guidance tool may further provide advertisements that offer goods or services that directly facilitate the accomplishment of each step. In this way, the techniques for providing the task-based advertisements may ensure that advertisements are displayed in the context of task guidance tools to self-selected users that are also potentially a highly motivated consumer.

In at least one embodiment, the task guidance tool may be developed from input data mined from various sources. The task guidance tool may display a series of step pages in which each step page include instructions for accomplishing a corresponding step of the task. Further, one or more step pages of the task guidance tool may be provided with selected advertisements that are displayed with the instructions.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements task-based advertisement delivery.

FIG. 2 is a block diagram that shows selected illustrative components of a computing device that implements a task-based advertising engine and illustrative components of a client device that presents a task guidance tool developed by the task-based advertising engine.

FIG. 3 is a flow diagram that illustrates an example process for developing a task guidance tool that includes embedded task-based advertisements.

FIG. 4 is a flow diagram that illustrates an example process for selecting one or more advertisements to be displayed with each step of a task outlined by a task guidance tool.

FIG. 5 is a flow diagram that illustrates an example process for presenting task-based advertisements embedded in each step page of a task guidance tool.

### DETAILED DESCRIPTION

The embodiments described herein pertain to techniques for providing task-based advertisements that offer goods or services that facilitate the accomplishment of a specific task by a user. For example, a user may face tasks such as buying a car, finding a first job, building a home, planning a wedding, and so forth. The techniques may include the development of a task guidance tool that breaks down a complicated task into a series of steps. For each of the steps, the task guidance tool may offer written instructions for accomplishing the step. In this way, rather than spending considerable amount of time and effort in researching an unfamiliar tasks, the user may seek out and rely on a task guidance tool to reduced an unfamiliar task into manageable steps, as well as receive specific knowledge and information that guides the user to accomplish each step.

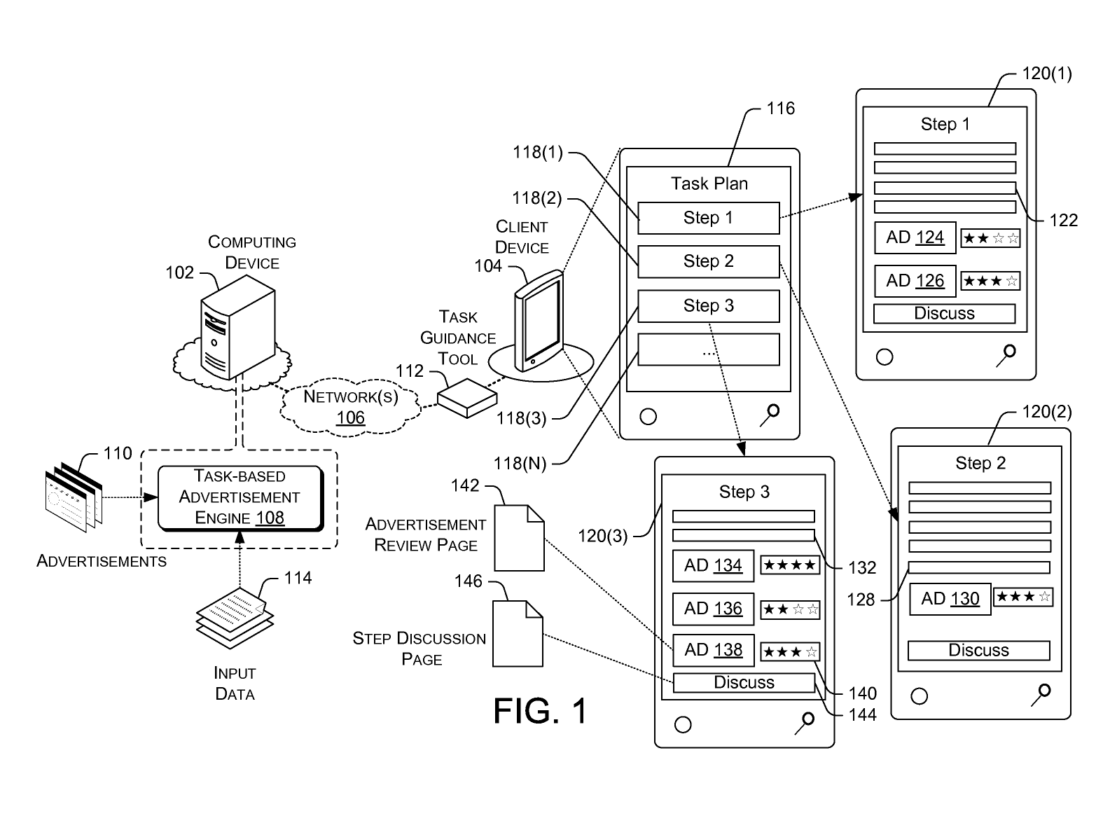

In addition to providing instructions for performing each step, the task guidance tool may provide advertisements that offer goods or services that directly facilitate the accomplishment of each step. For example, when a step in the task of finding a job is preparing and sending out resumes, the task guidance tool may, in addition to furnishing instructions for accomplishing this step, also display advertisements for books that offer resuming writing advice. In this way, the techniques for providing the task-based advertisements may ensure that advertisements are displayed to self-selected users that are also potentially highly motivated consumers. Advertisements delivery by the task-guidance tools described herein may be more effective than advertisement delivered via other delivery techniques, as a self-selected user is more likely to be interested in the advertisements than an average user who is simply browsing the Internet for information on different subjects and topics. Various examples of techniques for providing the task-based advertisements in accordance with the embodiments are described below with reference to FIGS. 1-5.

### Illustrative Environment

FIG. 1 is a block diagram of an illustrative environment 100 that implements task-based advertisement delivery. The illustrative environment 100 may include a computing device 102 and a client device 104 that are connected by one or more networks 106. The one or more networks 106 may be a local area network (“LAN”), a larger network such as a wide area network (“WAN”), and/or a collection of networks, such as the Internet. Protocols for network communication, such as TCP/IP, may be used to implement the one or more networks 106.

The computing device 102 may be a general purpose computer, such as a server, a desktop computer, and/or the like. In some embodiments, the computing device 102 may be substituted with a plurality of networked servers, such as servers in a cloud computing network.

The computing device 102 may implement a task-based advertisement engine 108 that produces task guidance tools, such as the task guidance tool 112. Each task guidance tool may break down a complicated task into a series of steps. Further, for each of the multiple steps, the task guidance tool may offer a page of instructions for accomplishing the step. For example, the task-based advertisement engine 108 may produce task guidance tools that instruct users on subjects such as finding a first job, building a house, owning a car, planning a wedding, and/or the like. The task guidance tools may be distributed to the users, so that users may rely on such task guidance tools to reduce unfamiliar tasks into manageable steps, as well as receive instructions and information that guides the users to accomplish each step.

In various embodiments, the task-based advertisement engine 108 may generate a task guidance tool, such as the task guidance tool 112, based on input data 114 that is mined from various sources. In at least one embodiment, data for accomplishing different tasks may be mined from multiple websites on the Internet by a web crawler. In other embodiments, data related to the performance of a variety of tasks may be contributed by online users. In some instances, the online users may be provided with monetary incentives for providing such information. On the other hand, some online users may contribute the information without any compensation.

The task-based advertisement engine 108 may further select one or more advertisements for display with each page of instructions presented by the task guidance tool. The one or more advertisements may be selected from advertisements 110 that are supplied by advertisers. Each advertisement may include a hyperlink that links to a merchant website that offers goods or services. Each advertisement may also include text, images, multimedia content, and/or interactive content (e.g., a login menu or a search form). The task-based advertisement engine 108 may select an advertisement for display on a page of instructions based on factors such as the relevance of the advertisement to the subject matter that is discussed in the page of instructions, the properties of the advertisement, and/or the fees that an advertiser who owns the advertisement is willing to pay for displaying an impression of the advertisement.

In some embodiments, the task-based advertisement engine 108 may insert one or more selected advertisements into a relevant page of the task guidance tool prior to the distribution of the task guidance tool to one or more client devices, such as the client device 104. However, in other embodiments, the task-based advertisement engine 108 may dynamically perform the selection of one or more advertisements for display on with a page of instructions as the page of the task guidance tool is being accessed by a user on a corresponding client device. In other words, rather than distributing a task guidance tool with pre-inserted advertisements, the task-based advertisement engine 108 may dynamically select and display the one more advertisements as the page of instructions is being viewed to ensure that the advertisements displayed are the most up-to-date.

The client device 104 may be a general purpose computer, such as a desktop computer, a laptop computer, a net book, a tablet computer, a mobile telephone, or the like. The client device 104 may receive a copy of a task guidance tool, such as the task guidance tool 112, via the network 106. A user of the client device 104 may download the task guidance tool 112 from the computing device 102 for a fee or free of charge.

The client device 104 may display the task guidance tool 112. The task guidance tool 112 may present a plan page 116 that shows a task plan for accomplishing a particular task with a series of steps, such as the steps 118(1)-118(N). Further, when a user selects a step for viewing, the task guidance tool 112 may display a corresponding page that shows the instructions for accomplish the step. For example, the selection of the step 118(1) may cause the task guidance tool 112 to display a step page 120(1), in which the step page 120(1) may include instructions for accomplishing an initial step in the particular task. Likewise, the selection of the step 118(2) may cause the task guidance tool 112 to display a step page 120(2) that includes instructions for accomplishing another step in the particular task. Further, the task guidance tool 112 may display a step page 120(3) that includes instructions for accomplishing an additional step in the particular task in response to the selection of the step 118(3), and so on and so forth.

Further, one or more step pages for the task guidance tool 112, such as the step pages 120(1)-120(3), may also display selected advertisements. Each of the advertisements may be inserted into a corresponding step page prior to the distribution of the task guidance tool 112, or dynamically inserted into a corresponding step page as the step page is selected for viewing. For example, the step page 120(1) may include advertisements 122 and 124 that are dynamically inserted by the task-based advertisement engine 108 as the user selects the step page 120(1) for viewing. Likewise, the step page 120(2) may include an advertisement 126 that is also dynamically inserted as the user selects the step page 120(2) for viewing. On the other hand, the step page 120(3) may include advertisements 130 and 132 that are inserted into the step page 120(3) prior to the distribution of the task guidance tool 112 to the client device 104. However, in other embodiments, a step page may include a mixture of pre-inserted and dynamically inserted advertisements. For example, the advertisement 128 may be pre-inserted into the step page 120(3) prior to distribution, while the advertisements 130 and 132 may be dynamically inserted as the user selects the step page 120(3) for viewing.

Further, as described above, the one or more advertisements that are inserted into a particular step page may be relevant to the content of the particular step page. For example, when the task guidance tool 112 is for accomplishing the task of finding a first job, the step page 120(1) may include instruction 122 on resume writing, and the advertisements 124 and 126 may be advertisements for books that offer tips on creating effective resumes. Likewise, in such an example, the step page 120(2) may include instructions 128 on preparing for an interview, and the advertisement 130 may be an advertisement for a clothing store that offers business attire. Further in the context of the example, the step page 120(3) may include instructions 132 on traveling for an interview, and the advertisements 134-138 may be advertisements for airlines or car rentals agencies. Accordingly, the advertisements that are displayed by the task guidance tool 112 displayed to a self-selected user that is also potentially a highly motivated consumer.

In some embodiments of the task guidance tool 112, each of the advertisements shown on a step page may be accompanied by a selectable feedback element that enables the user to rate and discuss the advertiser that placed the advertisement, as well as view other feedbacks for the advertiser. For example, the advertisement 138 may be accompanied by a selectable feedback element 140. The selectable feedback element 140 may display an average user rating of the advertiser that reflects other user impression of the advertiser associated with the advertisement 138. Upon a user selection, the selectable feedback element 140 may cause a corresponding advertisement review page 142 to be displayed on the computing device 102. The advertisement review page 142 may enable the user to view the subjective or objective comments of other users regarding their impressions of the advertiser associated with the advertisement 138 (e.g., quality of the goods or services provided, ease of use, promptness of the delivery, etc.).

The advertisement review page 142 may also display one or more scaled ratings provided by the other users regarding subjective or objective characteristics of the advertiser associated with the advertisement 138. For example, such characteristics may include an overall impression, quality of the goods or services delivered, promptness of delivery, effectiveness of communication, and/or the like. In at least one instance, the advertisement review page 142 may include an option that enables the user to filter the feedbacks so that only feedbacks from members within a social network of the user are displayed.

The advertisement review page 142 may also include a comment section that enables the user to leave feedback and/or a scaled rating regarding the advertisement. Thus, the selectable feedback element of each advertisement may enable the user to contribute feedback, as well as view other feedback that may facilitate cross comparison of advertisers when the user makes purchase decisions. As shown in FIG. 1, each of the advertisements on the step pages may be provided with an accompanying selectable feedback element.

In other embodiments, each of the step pages of the task guidance tool 112 may be provided with a discussion button that enables the user to comment on the instructions in step page. For example, the step page 120(3) may include a discussion button 144. Upon a user selection, the discussion button 144 may cause a corresponding step discussion page 146 to be displayed on the computing device 102. The step discussion page 146 may include a feedback view section that enables the user to view comments left by other users, as well as a comment section that enables the user to input comments. Such comments may include opinions as to whether the instructions on the step page are helpful, whether the instructions are understandable, whether the products described in the step page are useful, and/or the like. In at least one instance, the step discussion page 146 may include an option that enables the user to filter the feedbacks so that only feedbacks from members within a social network of the user are displayed. As shown in FIG. 1, each of the step pages may include a corresponding discussion button.

In additional embodiments of the task guidance tool 112, the plan page 116 that displays each of the steps 118(1)-118(N) may replaced with a navigation menu that is visible on each of the step pages 120(1)-120(3). For example, a navigation menu that includes a selectable menu item for each of the steps 118(1)-11(N) may be positioned along the bottom of the each step page. Accordingly, the navigation menu may enable a user to quickly navigate or skip to a different step page of the task guidance tool 112.

### Device Components

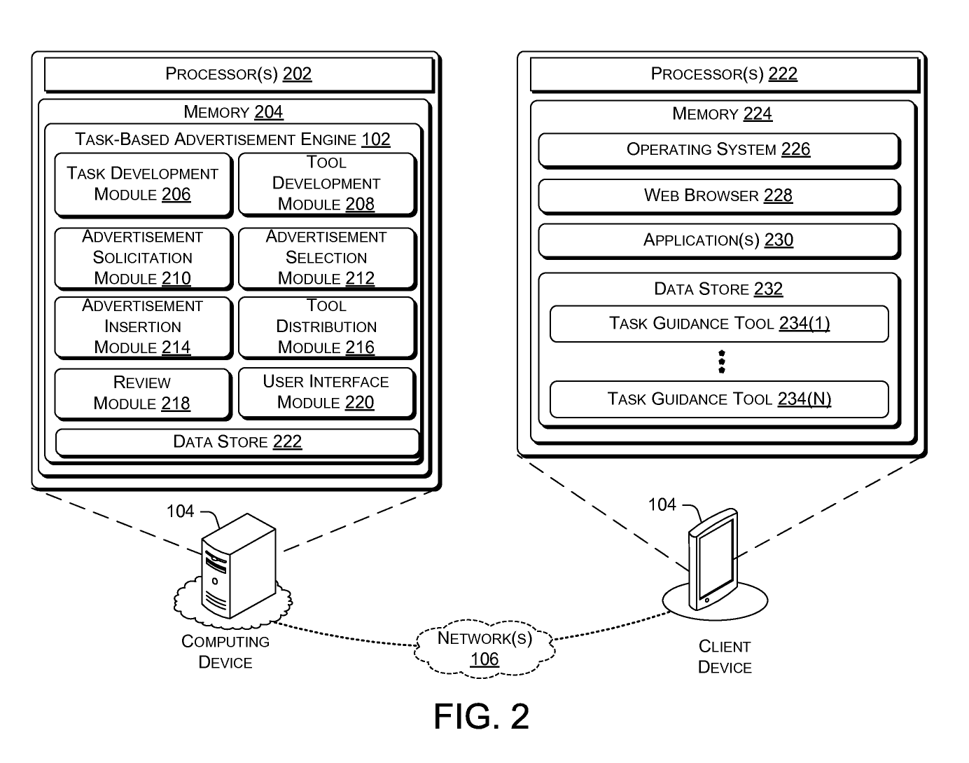

FIG. 2 is a block diagram that shows selected illustrative components of a computing device 102 that implements a task-based advertising engine 108 and illustrative components of a client device 104 that presents a task guidance tool developed by the task-based advertising engine.

The task-based advertisement engine 108 may be implemented on the computing device 102. The computing device 102 may include one or more processors 202, memory 204, and/or user controls that enable a user to interact with the client device. The memory 204 may be implemented using computer readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The computing device 102 may have network capabilities. For example, the computing device 102 may exchange data with other client devices (e.g., laptops computers, servers, etc.) via one or more networks, such as the network 106. The one or more processors 202 and the memory 204 of the computing device 102 may implement components of the task-based advertisement engine 108. The components may include a task development module 206, a tool development module 208, an advertisement solicitation module 210, an advertisement selection module 212, an advertisement insertion module 214, a tool distribution module 216, a user interface module 220, and a data store 222.

The task development module 206 may gather data for the development of task guidance tools, such as the task guidance tool 112. In some embodiments, the task development module 206 may use a web crawler to mine data from different websites on the Internet for information regarding the execution of various tasks. For example, an editor may configure the web crawler to seek out information related to the topic of contracting for the construction of a house. The task development module 206 may use a machine learning algorithm to compile the data gathered by the web crawler into discrete steps and step instructions. In some embodiments, the discrete steps and step instructions may be reviewed by an editor. The editor may manually edit the steps and the step instructions using an editing application provided by the task development module 206.

In other embodiments, the task development module 206 may obtain data regarding the execution of various tasks from online users. In such embodiments, a designer may use the task development module 206 to pose a request for information related to the execution of a task on an information request website. For example, the information request website may list a task to be accomplished, and provide an online template form for one or more online contributors to outline the steps and submit the instructions for accomplishing each step. The task development module 206 may also provide a review interface for the editor to manually review and edit the submitted steps and the instructions for the steps. In some instances, the task development module 206 may provide monetary incentives to the online contributors for their contributions.

The step instructions that the task development module 206 gathers for each step of a task may include text information, graphics, images, video clips, audio clips, and/or multimedia clips. In some instances, the task development module 206 may use machine learning techniques to identify current popular topics for conversion into executable tasks instead of relying on human editors to come up topics. Once the steps and step instructions for accomplishing a task has been collected, the task development module 206 may further pass the information regarding the steps and step instructions as a data collection to a tool development module 208 for assembly into a corresponding task guidance tool.

The tool development module 208 may receive data collections of steps and step instructions for accomplishing tasks from the task development module 206. In turn, the tool development module 208 may convert each data collection into a task guidance tool, such as the task guidance tool 112. In various embodiments, the tool development module 208 may provide a configuration interface that enables the designer to select configuration settings or a guidance tool template for converting a data collection into a task guidance tool. Each guidance tool template may include settings for background, styles, graphics, font, user interface options (e.g., selectable feedback elements for advertisements and discussion buttons), placement of user interface options, step page organization, number of advertisements to display on a step page, and/or other configuration settings.

In this way, the tool development module 208 may automatically convert a data collection into a corresponding task guidance tool using the selected configuration settings and/or guidance tool templates. In some embodiments, the tool development module 208 may also provide an editing interface that enables the user to review and edit the instructional content in each step page of the task guidance tool created by the tool development module 208. The editing interface may enable the user to manually create and edit step pages to generate a task guidance tool. As further described below, a task guidance tool that is generated with the use of the tool development module 208 may have the ability to request advertisements from the task-based advertisement engine 108.

In some embodiments, a task guidance tool generated by the tool development module 208 may be a stand-alone application that is executable on a client device to display the step pages and/or advertisements. Alternatively, the generated task guidance tool may be a downloadable document whose content is viewable via a companion viewing application. However, in additional embodiments, a task guidance tool that is generated by the tool development module 208 may be a dynamic web page or a series of linked web pages that present interactive step pages and/or advertisement content. Accordingly, rather than downloading the task guidance tool, a user may use a web browser on a client device to navigate to the dynamic web page or the series of web pages to interface with the task guidance tool. Further, a task guidance tool for accomplishing a particular task may be packaged by the tool development module 208 in multiple formats (e.g., as both a stand-alone application and a dynamic web page).

The advertisement solicitation module 210 may solicit advertisements for insertion into the step pages of task guidance tools. In various embodiments, the advertisement solicitation module 210 may provide an interface portal that enables advertisers to submit bids for the display of their advertisements with each task guidance tool. For example, the advertisement solicitation module 210 may generate a list of subjects and subject descriptions based on the content in the step pages of different task guidance tools. The list of subjects and subject descriptions are displayed by the interface portal. In turn, the interface portal may include a web submission interface for advertisers to submit advertisements or links to advertisements, as well as to designate the particular subject associated with each submitted advertisement. The web submission interface may also provide an online form for each advertiser to submit a bid amount that the advertiser intends to pay for each displayed impression of its advertisement. In some embodiments, the web submission interface may be configured as an auction interface in which each advertiser is able to view the bid amounts of other advertisers, so that the advertisers may be encouraged to increase their bids.

The advertisement selection module 212 may select advertisements that are submitted by advertisers for insertion into step pages of task guidance tools. In various embodiments, a filtering algorithm may be used by the advertisement selection module 212 to filter out submitted advertisements that are unsuitable for display with the task guidance tools. For example, submitted advertisements that contain objectionable, illegal, and/or unauthorized content may be identified by the filtering algorithm through machine recognition techniques and filtered out. The filtering algorithm may also exclude advertisements that are from disreputable advertisers, such as advertisers that are known spammers, illegitimate businesses, advertisers that previously submitted unsuitable advertisements, and/or advertisers that are otherwise judged to be unsuitable. For such purpose, the advertisement selection module 212 may maintain and update a database of excluded advertisers and/or advertiser websites.

The advertisement selection module 212 may further match the filtered advertisements to step pages. In some instances, an advertisement may be matched to a step page based on the subject associated with the advertisement as indicated by the submitting advertiser. In other instances, the advertisement selection module 212 may use a relevancy matching algorithm to match an advertisement to a step page based on the content of the advertisement and the instructional content of the step page. In scenarios in which there is a single advertisement that matches a step page, the advertisement selection module 212 may select the single advertisement for insertion into the step page.

In other scenarios, the number of advertisements that match a particular step page may exceed the maximum number of advertisements that may be displayed on the particular step page. In such scenarios, the advertisement selection module 212 may select one or more advertisements from the matching advertisements for display on the particular step page. As described above, the maximum number of advertisements to be displayed may be configured via the tool development module 208.

The selection of the one or more matching advertisements by the advertisement selection module 212 for display on the particular step page may be based on the respective bid amounts offered by advertisers. For example, if the particular step page is configured to show one advertisements, then a matching advertisement from the pool with the highest bid amount may be selected for display on the particular web page. In another example, if the particular step page is configured to shown two advertisements, then two matching advertisements from the pool with the two highest bid amounts may be selected for display on the particular step page, and so on and so forth.

Further, in instances in which multiple matching advertisements are selected for display on a step page, the multiple matching advertisements may be positioned on the step page according to their respective bid amounts. For example, a matching advertisement with the highest bid amount may be positioned in the most prominent location (e.g., the highest position on the step page), while a matching advertisement with the second highest bind may be positioned in a less prominent position, and so on and so forth until all the multiple matching advertisement are arranged.

However, in scenarios in which no matching advertisement is found for a step page by the advertisement selection module 212, the advertisement selection module 212 may refrain from inserting advertisements into a step page.

In some embodiments, the advertisement selection module 212 may be configured to perform the selection of one or more advertisements for insertion into step pages of a task guidance tool prior to the distribution of the task guidance tool to client devices. In other embodiments, the advertisement selection module 212 may periodically perform the selection (e.g., once every minute, hour, day, etc.) so that the advertisements that are displayed by the step pages of the task guidance tools may be regularly updated. Alternatively, the advertisement selection module 212 may dynamically perform the selection of the one or more advertisements for insertion into a step page of a task guidance tool each time the step page is viewed.

In the latter embodiments, a copy of the task guidance tool 112 that is presented to a user via the client device 104 may make a request for one or more advertisements to be displayed on a step page when the user selects the step page for viewing. In turn, the advertisement selection module 212 may provide the latest periodically selected relevant advertisements for insertion into the step page. Alternatively, the advertisement selection module 212 may dynamically perform an advertisement selection to determine one or more highest bidding relevant advertisements for insertion into the step page.

The advertisement insertion module 214 may insert the advertisements that are selected for display in each step page of a task guidance tool into the corresponding step page. In some embodiments, the advertisement selection module 212 may command the advertisement insertion module 214 to insert one or more advertisements into step pages of a task guidance tool prior to the distribution of the task guidance tool to the client devices. In other embodiments, the advertisement selection module 212 may command the advertisement insertion module 214 to insert one or more of the latest periodically selected advertisements or alternatively, one or more dynamically selected advertisements into step pages of a task guidance tool that is on a client device (e.g., client device 104). In the latter embodiments, each advertisement insertion may be performed in response to an advertisement insertion request from the task guidance tool that is on the client device. Such insertion may involve the transmission of the one or more advertisements from the task-based advertisement engine 108 over the network 106 to the client device.

The tool distribution module 216 may distribute the task guidance tools to one or more client devices, such as the client device 104. The tool distribution module 216 may make available to client devices an interface page that presents the different available task guidance tools. The interface page may be a web page that is accessible from a client device via a web browser, or an application interface page that is viewable via an application that is running on a client device.

Accordingly, a client device may initiate a request for a particular task guidance tool. For example, a user who is interaction with the client device 104 may wish to acquire a task guidance tool that facilitates the planning of a wedding. Accordingly, the user may initiate a request for a wedding planning task guidance tool using the interface page displayed on the client device 104. The user may also specify the format of the task guidance tool requested, such as a stand-alone application, a document, dynamic web page content, or a series of linked web pages. In response to the request, the tool distribution module 216 may retrieve the requested task guidance tool from the data store 222 and provide the requested task guidance tool of the requested format to the client device 104 via the network 106.

The review module 218 may interface with each task guidance tool, such as the task guidance tool 112, to provide review pages (e.g., web pages) that display feedback related to the advertisements and instructions in step pages. The feedback may include one or more of scaled ratings or comments on subjective and/or objective attributes of one or more advertisements. The feedback may also include opinions and impressions on the instructions in one or more step pages. Additionally, the review pages provided by the review module 218 may further enable users to input feedback with respect to the advertisements and/or instructions in the step pages of each task guidance tool. Accordingly, the review module 218 may have the ability to receive, sort, update, and store the feedbacks in the data store 222, as well as retrieve and present each feedback with the appropriate advertisement and/or step page.

The user interface module 220 may enable a user to interact with the modules of the task-based advertisement engine 108 using a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In various embodiments, the user interface module 220 may enable a user interact with the review interface of the task development module 206, the configuration interface of the tool development module 208. The user interface module 220 may further enable users to change the configuration settings of the advertisement solicitation module 210, the advertisement selection module 212, and the advertisement insertion module 214. For example, a user may use the user interface module 220 to update the list of subjects displayed by the advertisement solicitation module 210, and/or adjust the filtering algorithm or the list of disreputable advertisers used by the advertisement selection module 212.

The data store 222 may store the advertisements submitted by the advertisers and their association with subjects, as well as the bid amounts offered for displaying the impressions of the advertisements. The data store 222 may also store the relevancy matches between advertisements and contents of step pages, as well as the selections of advertisements for display on step pages of task guidance tools. The data store 222 may also store the different task plans that are generated by the task development module 206, as well as the different task guidance tools that are developed by the tool development module 208. Additionally, the data store 222 may also store values or other intermediate products that are generated or used by various modules of the task-based advertisement engine 108.

The client device 104 may be one of the electronics devices that enable a user to obtain and use the task guidance tools generated by the task-based advertisement engine 108. The client device 104 may be a general purpose computer, such as a desktop computer, a tablet computer, a laptop computer, a server, and so forth. However, in other embodiments, the client device 104 may be one of a camera, a smart phone, a game console, a personal digital assistant (PDA), and so forth.

The client device 104 may include one or more processors 222, memory 224, and/or user controls that enable a user to interact with the client device. The memory 224 may be implemented using computer readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The client device 104 may have network capabilities. For example, the client device 104 may exchange data with other client devices (e.g., laptops computers, servers, etc.) via one or more networks, such as the network 106. In some embodiments, the client device 104 may be substituted with a plurality of networked servers, such as servers in a cloud computing network.

The one or more processors 222 and the memory 224 of the client device 104 may implement components that include an operating system 226, a web browser 228, one or more applications 230, and a data store 232.

The operating system 226 may enables the client device 104 to receive data via various inputs (e.g., user controls, network interfaces, and/or memory devices), and processes data using the one or more processors 222 to generate output. The operating system may also include a display function that presents the output (e.g., displays the output on an electronic display, stores data in memory, transmits data to another client device, etc.). The operating system may further provide resources and services for the implementation and execution of various applications. Additionally, the operating system may perform various other functions generally associated with such a system, such as enabling a user to interact with the various applications on the client device 104. Nevertheless, in some embodiments, the applications stored in the memory 224 may be configured to function without the operating system 226.

The web browser 228 may enable a user to request one or more task guidance tool from a list of available task guidance tools, as presented by the task-based advertisement engine 108 via an interface page. Additionally, the web browser 228 may also enable the user to download or view the one or more task guidance tools using the client device 104. In some instances, the user may also use the web browser 228 to access the web submission interface provided by the advertisement solicitation module 210.

The one more applications 230 may include an application that enables the user to request one or more guidance tools from the list of available guidance tools. For example, the application may be a stand-alone program that is designed to facilitate the selection and download of task guidance tool from the task-based advertisement engine 108. Alternatively or concurrently, the applications 230 may also include a companion viewing application that facilitates user interaction and viewing of task guidance tools in the form of documents. In other embodiments, the applications 230 may include a stand-alone program that enables the user to interact with the interface portal of the advertisement solicitation module 210, so that the user may submit advertisements and associated impression bids.

The data store 232 may store task guidance tools, such as the task guidance tools 234(1)-234(N) that are download to the client device 104. Each of the downloaded task guidance tools 234(1)-234(N) may be in the form of a stand-alone application, a document, dynamic web page content, or a series of linked web pages. Accordingly, as the user interacts with each of the task guidance tools 234(1)-234(N), the user may be provided with step pages that include instructions for achieving series of steps to accomplish tasks, as well as advertisements for goods or services that facilitate the execution of the steps.

### Example Processes

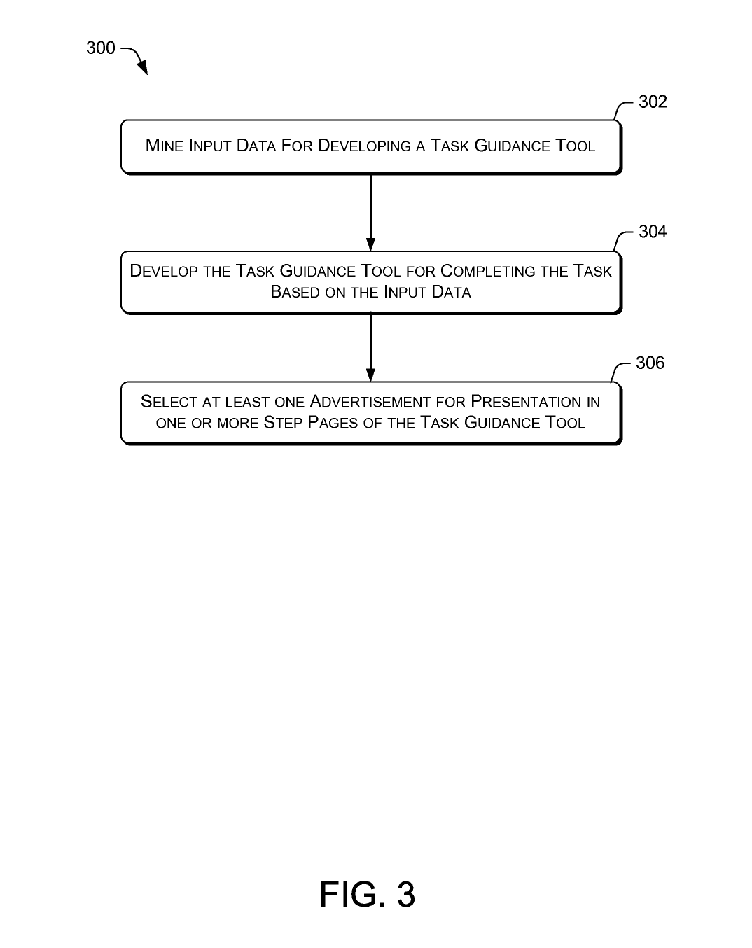

FIGS. 3-5 describe various example processes for exposing users to task-based advertisements via task based guidance tools. The order in which the operations are described in each example process is not intended to be construed as a limitation, and any number of the described operations may be combined in any order and/or in parallel to implement each process. Moreover, the operations in each of the FIGS. 3-5 may be implemented in hardware, software, and a combination thereof. In the context of software, the operations represent computer-executable instructions that, when executed by one or more processors, cause one or more processors to perform the recited operations. Generally, computer-executable instructions include routines, programs, objects, components, data structures, and so forth that cause the particular functions to be performed or particular abstract data types to be implemented.

FIG. 3 is a flow diagram that illustrates an example process 300 for developing a task guidance tool that includes embedded task-based advertisements.

At block 302, the task development module 206 may mine input data for developing a task guidance tool. The input data may include data that is mined from different websites on the Internet. Alternatively or concurrently, the input data may include data that is contributed by online users in response to request for information. The task development module 206 may compile the task completion data that is gathered from the different websites and/or from the online contributors into discrete steps and step instructions. The series of steps and steps instructions may be stored as a data collection. In some embodiments, the series of steps and step instructions may be reviewed and/or modified by an editor.

At block 304, the tool development module 208 may develop the task guidance tool for completing the task based on the input data. In various embodiments, the tool development module 208 may automatically convert the data collection into a corresponding task guidance tool using selected configuration settings and/or guidance tool templates. In some embodiments, tool development module 208 may also provide an editing interface that enables the user to manually edit or update each step page during the creation of the task guidance tool.

At block 306, the advertisement selection module 212 may select at least one advertisement for presentation on one or more step pages of the task guidance tool. The maximum number of advertisements to be selected for display on each step page may be configured via the tool development module 208. In various embodiments, the selection of each advertisement for display in a corresponding step page may be based on the relevancy of the advertisement to the corresponding step page, the suitability of the advertisement, and/or the bid amount offered by an advertiser for displaying impressions of the advertisement. In various embodiments, each of the one or more displayed advertisements may be accompanied by a corresponding selectable feedback element, and each of one or more step pages of task guidance tool may include a corresponding discussion button that enables users to leave feedback.

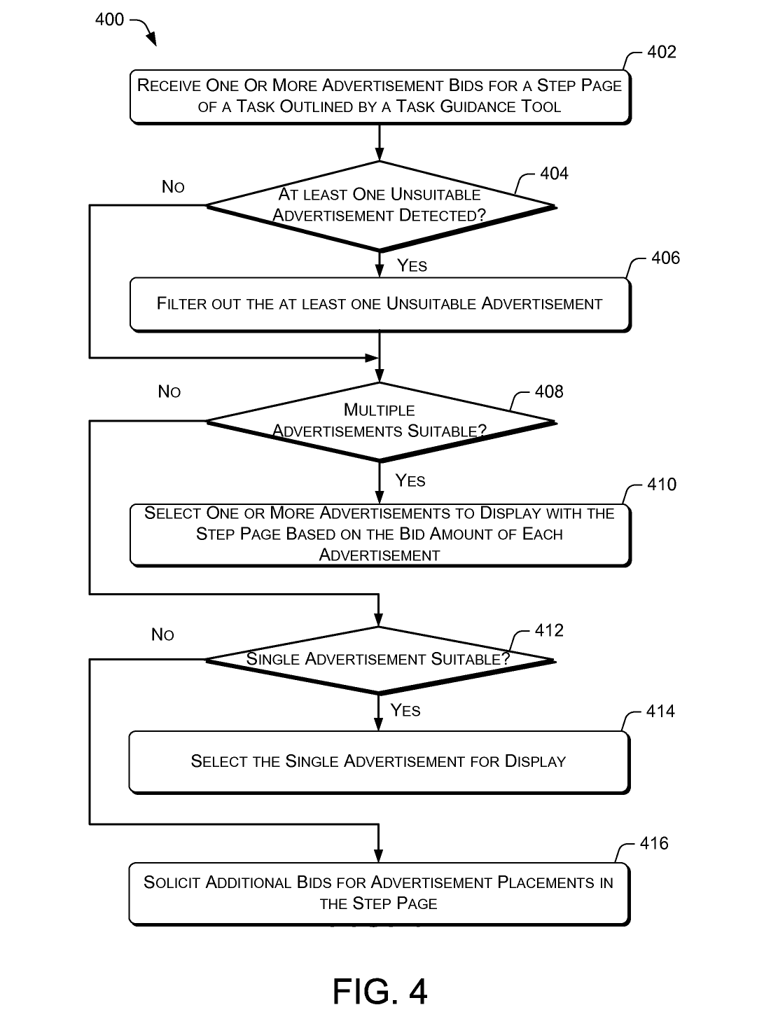

FIG. 4 is a flow diagram that illustrates an example process 400 for selecting one or more advertisements to be displayed with each step of a task outlined by a task guidance tool. The example process 400 may further illustrate the block 306 of the example process 400.

At block 402, the advertisement selection module 212 may receive one or more bids for placing advertisements in a step page of a task outlined by a task guidance tool. In various embodiments, the bids may be received in response to a request for advertisements related to one or more subjects.

At decision block 404, the advertisement selection module 212 may determine whether at least one suitable advertisement is detected. In various embodiments, an advertisement may be deemed unsuitable when the advertisement contains objectionable, illegal and/or unauthorized content, or when the advertisement is from a disreputable advertiser. Thus, if the advertisement selection module 212 determines that at least one unsuitable advertisement is detected (“yes” at decision block 404), the process 400 may continue to block 406. At block 406, the advertisement selection module 212 may filter out the at least one unsuitable advertisement. In other words, the advertisement selection module 212 may exclude the one or more unsuitable advertisements from being selected for display in the step page of the task guidance tool. However, if the advertisement selection module 212 determines that no unsuitable advertisements are detected (“no” at decision block 404″), the process 400 may continue directly to decision block 408.

At decision block 408, the advertisement selection module 212 may determine whether there are still multiple suitable advertisements remaining after the filtering. If the advertisement selection module 212 determines that there are multiple suitable advertisements remaining (“yes” at decision block 408), the process 400 may proceed to block 410.

At block 410, the advertisement selection module 212 may select one or more advertisements from the multiple suitable advertisements to display in the step page based on the bid amount of each advertisement. The bid amounts are the monetary value that advertisers offer for showing impressions of the multiple suitable advertisements. In various embodiments, the maximum number of advertisements to be displayed on a step page may be dependent on the configuration of the step page via the tool development module 208. Accordingly, the advertisement selection module 212 may select one or more suitable advertisements up to the maximum number for display in the step page, in which each selected advertisement has either the highest bid amount or one of the highest bid amounts.

However, returning to decision block 408, if the advertisement selection module 212 determines that there are less than multiple suitable advertisements remaining (“no” at decision block 408), the process 400 may proceed to decision block 412.

At decision block 412, the advertisement selection module 212 may determine whether there is a single suitable advertisement remaining after filtering. If the advertisement selection module 212 determines that is a single suitable advertisement remaining (“yes” at decision block 412), the process 400 may continue to block 414.

At block 414, the advertisement selection module 212 may select the single advertisement for display in the step page. In at least one embodiment, the single advertisement may be selected for display without regard to the associated bid amount.

Returning to decision block 412, if the advertisement selection module 212 determines that are no suitable advertisements remaining after the filtering (“no” at decision block 412), the process 400 may proceed to block 416. At block 416, the advertisement selection module 212 may use the advertisement solicitation module 210 to solicit additional bids for advertisement placements in the step page.

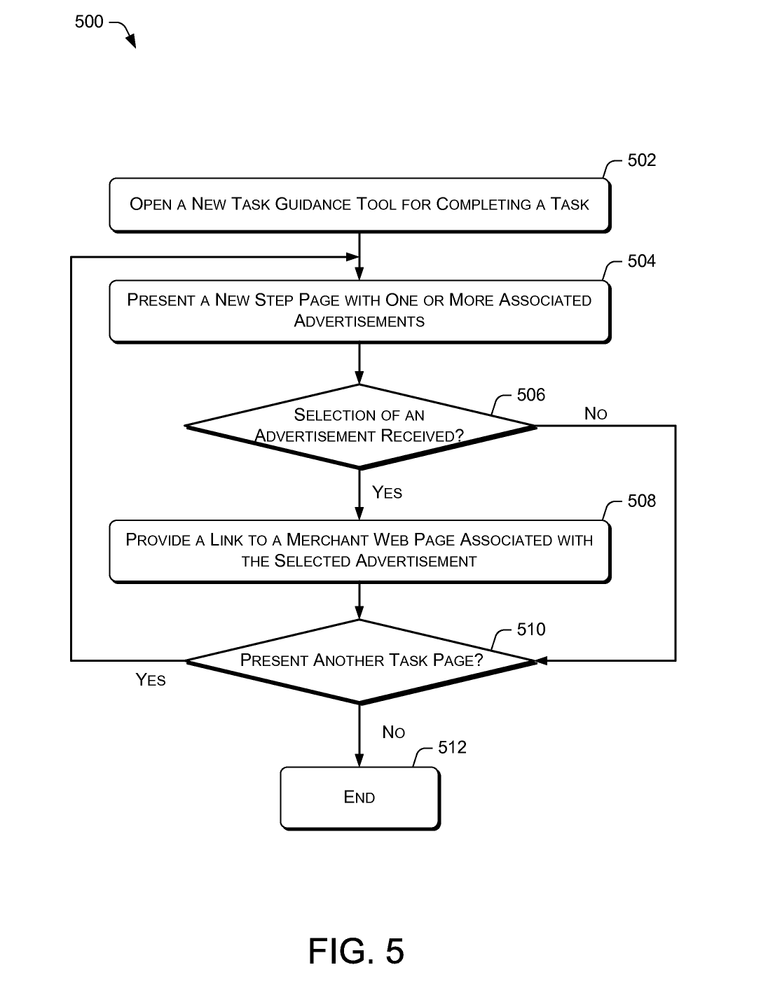

FIG. 5 is a flow diagram that illustrates an example process 500 for presenting task-based advertisements embedded in each step page of a task guidance tool. At block 502, a user may open a new task guidance tool on a client device, such as the client device 104, to obtain information on completing a task. At block 504, the task guidance tool may present a new step page with one or more associated advertisements.

The task guidance tool may present the new task step in response to a user interaction. In some embodiments, the one or more associated advertisements may have been pre-embedded in the guidance tool prior to distribution to the client device. In other embodiments, the task guidance tool may dynamically obtain the one or more associated advertisements from the advertisement insertion module 214 of the task-based advertisement engine 108 when the step page is displayed on the client device.

At decision block 506, the task guidance tool may determine whether a selection of an advertisement on the new step page is received. For example, the user may select the advertisement by clicking on the advertisement in the new step page. Accordingly, if the task guidance tool determines that the selection of an advertisement is received (“yes” at decision block 506), the process 500 may proceed to block 508.

At block 508, the advertisement that is selected may provide a link to a merchant web page that is associated with the selected advertisement. The link may navigate a web browser to the merchant web page so that a user may review or purchase goods and/or services associated with the selected advertisement.

At decision block 510, the task guidance tool may determine whether another task step is to be presented. The task guidance tool may present another task step in response to another user interaction with the task guidance tool. For example, the user may wish to view another step page that includes instructions for facilitating the completion of the task. Accordingly, if the task guidance tool receives a request to display another step page (“yes” at decision block 510), the process 500 may loop back to block 504 so that another new step page that includes one or more advertisements may be presented. However, if the task guidance tool receives no other step page presentation request (“no” at decision block 510), the process 500 may terminate at block 512.

A task guidance tool that breaks a task into a series of simplified instructional steps may facilitate the accomplishment of the task by users who are otherwise unfamiliar with the task. Further, in addition to providing instructions for each step, the task guidance tool may provide advertisements that offer goods or services that directly facilitate the accomplishment of each step. In this way, such task-based advertisements may be displayed to self-selected users that are also potentially highly motivated consumers.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer-readable medium storing computer-executable instructions that, when executed, cause one or more processors to perform acts comprising:
mining input data for developing a task guidance tool for completing a task;
developing the task guidance tool that includes a plurality of step pages based on the input data, each step page including instructions for accomplishing a corresponding step of a task; and
selecting at least one advertisement for display in one or more step pages of the task guidance tool.

2. The computer-readable medium of claim 1, further comprising instructions that, when executed, cause the one or more processors to perform acts of:
receiving a request for the task guidance tool from a client device; and
delivering the task guidance tool to the client device for consumption by a user.

3. The computer-readable medium of claim 1, further comprising instructions that, when executed, cause the one or more processors to perform acts of:
receiving one or more relevant advertisements for display in the one or more step pages of the task guidance tool in response to a solicitation; and
filtering out at least one unsuitable advertisement from the one or more relevant advertisements.

4. The computer-readable medium of claim 1, further comprising instructions that, when executed, cause the one or more processors to perform an act of inserting an advertisement into a step page of the task guidance tool.

5. The computer-readable medium of claim 4, wherein the inserting comprises inserting the advertisement into the step page prior to a delivery of the task guidance tool to a client device or upon receiving a request to present the step page for display on the client device.

6. The computer-readable medium of claim 1, wherein the mining comprises obtaining data from a plurality of websites or receiving manually inputted data from one or more users.

7. The computer-readable medium of claim 1, wherein the developing comprises:
compiling the input data into a plurality of instructional steps for completing the task; and
converting the plurality of instructional steps into a task guidance tool based at least on a guidance tool template and a configuration setting that determines a number of advertisements to display on each step page of the task guidance tool.

8. The computer-readable medium of claim 7, wherein the developing comprises implementing a manual edit to at least one of an instructional step or instructional content of a step page.

9. The computer-readable medium of claim 1, wherein the task guidance tool comprises:
a stand-alone application;
a document that is viewable via a viewing application;
a dynamic web page that includes interactive content; or
a series of linked web pages.

10. The computer-readable medium of claim 1, wherein the selecting comprises:
matching an advertisement to a step page based on content relevance of the advertisement to instructional content of the step page; and
selecting the advertisement for display on the step page when the advertisement is a sole advertisement that is relevant to the step page or when an bidding amount offered for displaying an impression of the advertisement qualifies the advertisement for display on the step page.

11. The computer-readable medium of claim 1, wherein the selecting comprises:
selecting an advertisement for display on a step page prior to a delivery of the task guidance tool to a client device,
selecting the advertisement for display on the step page during a periodic advertisement selection, or
selecting the advertisement for display on the step page upon receiving a request to present the step page for display on a client device.

12. A computer-implemented method, comprising:
presenting a step page of a task guidance tool for display on a client device, the step page including a first area that provides instructions for completing a step that contributes to accomplishment of a task and a second area that displays a relevant advertisement for a product or a service that facilitates completion of the step; and
navigating a web browser to a web page related to the product or the service upon a selection of the relevant advertisement by a user.

13. The computer-implemented method of claim 12, further comprising downloading the task guidance tool from a computing device to the client device.

14. The computer-implemented method of claim 12, further comprising receiving a request to view the step page of the task guidance tool via a user interaction with a menu item displayed on another step page, wherein the presenting includes presenting the step page in response to the request.

15. The computer-implemented method of claim 12, wherein the relevant advertisement is accompanied by a selectable feedback element that leads to a page that enables the user to view or leave feedback regarding an advertiser associated with the relevant advertisement, and the step page includes a discussion button that leads to an additional page that enables the user to view or leave feedback regarding the instructions in the step page.

16. The computer-implemented method of claim 12, wherein the relevant advertisement is pre-embedded in the step page or dynamically downloaded from a computing device for presentation in the step page upon display of the step page on the client device.

17. The computer-implemented method of claim 12, wherein the relevant advertisement is selected for display in the step page based on a bidding amount that is offered for displaying an impression of the advertisement being higher than an additional bidding amount associated with another relevant advertisement.

18. A computing device, comprising:
one or more processors; and
a memory that includes a plurality of computer-executable components, the plurality of computer-executable components comprising:
a task development component that acquires input data regarding steps that facilitate accomplishment of a task from at least one of one or more websites or manual input from one or more users;
a tool development component that develops a task guidance tool that includes one or more step pages based on the input data, each step page including instructions for accomplishing a corresponding step of the task;
an advertisement selection component that selects at least one advertisement for display in the one or more step pages of the task guidance tool based at least on relevance of the at least one advertisement to instructional content of each step page; and
an advertisement insertion component that inserts an advertisement into a step page of the task guidance tool.

19. The computing device of claim 18, wherein the tool development component develops the task guidance tool at least by:
compiling the input data into a plurality of instructional steps for completing the task; and
converting the plurality of instructional steps into a task guidance tool based at least on a guidance tool template.

20. The computing device of claim 18, wherein the advertisement selection component is to select an advertisement for display in a step page at least by:
matching the advertisement to the step page based on content relevance of the advertisement to the instructional content of the step page; and
selecting the advertisement for display on the step page when the advertisement is a sole advertisement that is relevant to the step page or when an bidding amount offered for displaying an impression of the advertisement qualifies the advertisement for display on the step page.
